(19) United States
(12) Patent Application Publication
(10) Pub. No.: US 2007/0103326 A1
(43) Pub. Date: May 10, 2007

(54) Operation indicator

(76) Inventors: Joseph P. Moninski, Arlington Heights, IL (US); Brian P. Mugalian, Evanston, IL (US)

Correspondence Address: James V. Lapacek;S & C Electric Co., 6601 N. Ridge Blvd., Chicago, IL, 60626, US

(21) Appl. No.: 11/543,290

(22) Filed: Oct. 3, 2006

Related U.S. Application Data
(60) Provisional application No. 60/730,284, filed on Oct. 26, 2005.

(51) Int. Cl. G08B 21/00

(52) U.S. Cl. 340/635

(57) ABSTRACT

A multi-mode control indicator is provided for use with an electrical device. The multi-mode control indicator 20 provides multiple status indications via respective display modes (display patterns), e.g. steady “on” state, flashing, off, or various other patterns of differing intensities. In a preferred arrangement, the device is controlled via a wireless communication channel.

This application claims the benefit of U.S. Provisional Application No. 60/730,284 filed Oct. 26, 2005.

### BACKGROUND OF THE INVENTION

1. Field of the Invention

The present invention relates generally to the field of indicators and, more particularly, to an operation indicator in the electrical power field for a control that is operable in multiple modes and controlling a device that is inaccessible or remotely located.

2. Description of the Related Art

Various indicators are known for visibly displaying the operational status of a device. For example, U.S. Pat. No. 4,231,028 is directed to a ready indicator for switchgear that is activated when a number of predetermined operational conditions are met. In U.S. Pat. No. 5,796,347, the output of information is controlled from a device in an inaccessible location.

While the prior art arrangements may be generally useful, they do not provide for desirable visibility of operational states in remote or inaccessible locations.

### BRIEF DESCRIPTION OF THE DRAWING

The invention, both as to its organization and method of operation, together with further objects and advantages thereof, will best be understood by reference to the specification taken in conjunction with the accompanying drawing in which:

FIG. 1 is a diagrammatic representation of a multi-mode control indicator in accordance with the present invention and illustrated in conjunction with an illustrative device to which the operation indicator responds.

### DETAILED DESCRIPTION

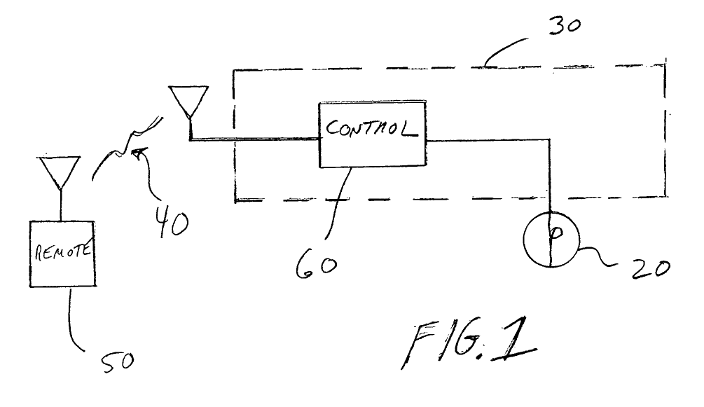

Referring now to FIG. 1, a multi-mode control indicator 20 of the present invention is provided for use with an electrical device 30, e.g. a switch or circuit interrupter that includes an automatic testing and closing feature in a specific implementation. In an illustrative implementation, the multi-mode control indicator 20 is arranged to provide multiple status indications via respective display modes (display patterns), e.g. steady “on” state, flashing, off, or various other patterns of differing intensities. In a preferred arrangement, the device 30 is controlled via a wireless communication channel indicated at 40. For example, in an illustrative specific example, a remote transmitter 50 controls the operational mode of the device 30 via the communication channel 40 and a control 60 located within the overall device 30. Thus, the operational mode of the control 60 is selected via the remote transmitter 50 and a feedback to the user is provided via the multi-mode control indicator 20, i.e. the mode or status of the control 60 and the device 30 are fed back to the user of the remote transmitter 50 via the indicating state of the multi-mode control indicator 20.

In an illustrative example, the control 60 is operable in an automatic mode and the multi-mode control indicator 20 is in a steady “on” indicating state to so indicate. If the remote transmitter 50 is used to switch off the automatic state of the control 60, the multi-mode control indicator changes state to provide a flashing indication. The control 60 may also be programmed to provide an acknowledgment that the remote transmitter 50 has addressed and actuated the correct control 60. In a specific implementation, this is accomplished by the multi-mode control indicator 20 being controlled to blink one or more times. If the multi-mode control indicator 20 is off, this indicates an error condition within the control 60 and/or multi-mode control indicator 20. Of course, it should be realized that various other display patterns of the multi-mode control indicator 20 may be provided that correspond to other operational modes of the device 30.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

1. A multi-mode control indicator arrangement for a device operable in a plurality of operational modes via a control for the device, the arrangement comprising:
a control responsive to inputs representing the desired mode of operation of the device; and
an indicator responsive to the control for providing multiple display modes corresponding to different operational states of the device.

2. The multi-mode control indicator arrangement of claim 1 wherein said multiple display modes include a steady on display mode and a flashing display mode.

3. The multi-mode control indicator arrangement of claim 2 wherein said multiple display modes include a first temporary display pattern followed by a second permanent display pattern.

4. The multi-mode control indicator arrangement of claim 2 wherein said multiple display modes include an off display mode corresponding to an error condition.

5. A multi-mode control indicator arrangement for a remote device comprising:
first means for communicating with the remote device to control the device in a plurality of operational modes; and
an indicator responsive to the plurality of operational modes of the device to provide respective different indicating states or display patterns.
